(19) United States
(12) Patent Application Publication
(10) Pub. No.: US 2026/0184823 A1
(43) Pub. Date: Jul. 2, 2026

(54) ZIEGLER NATTA CATALYST FOR OLEFIN POLYMERIZATION

(71) Applicant: Braskem America Inc., Philadelphia, PA (US)

(72) Inventors: Sumant Dwivedi, Pittsburgh, PA (US); Eunil Kim, Pittsburgh, PA (US); Valerie Shaffer, Pittsburgh, PA (US); Nicholas Sanzo, Pittsburgh, PA (US)

(21) Appl. No.: 19/413,955

(22) Filed: Dec. 9, 2025

Related U.S. Application Data
(60) Provisional application No. 63/739,426, filed on Dec. 27, 2024.

(51) Int. Cl. C08F 4/602; C08F 4/606

(52) U.S. Cl. CPC C08F 4/602; C08F 4/606

(57) ABSTRACT

A catalyst can include a solid reaction product of: a non-halide containing organic compound (A) having an element from Groups Ia, IIa, IIb, IIIb, IVb, VIIa, and VIII; a non-halide containing transition metal compound (B) having a transition metal from Groups IVa, Va, and Via; and an organo-aluminum halide represented by AlR(R′)ₙ, where R represents a C₁-C₂₀ hydrocarbon radical, R′ represents a halide, and n represents 0≤n≤2. The disclosure also relates to methods of preparing the catalyst.

### CROSS REFERENCE TO RELATED APPLICATIONS

The present application claims the benefit of U.S. Provisional Patent Application No. 63/739,426, filed on Dec. 27, 2024.

### BACKGROUND OF THE INVENTION

Polyolefin catalysts, such as Ziegler-Natta catalysts, are often produced by complex, multi-step syntheses. A traditional way to prepare the Ziegler-Natta catalyst is by preparing a solution of magnesium ethoxide and titanium butoxide, often in the presence of aluminum species as a viscosity modifier, at the higher temperatures, followed by the addition of alkyl aluminum chloride, to yield the Ziegler-Natta catalyst.

Requirements for the catalyst reagents are quite rigid, especially for the magnesium ethoxide, in terms of purity, particle size, and the like. These rigid requirements promote a complexity of the catalyst synthesis. For example, magnesium ethoxide is a solid, and preparing a homogeneous complex with titanium butoxide requires higher synthesis temperatures, such as greater than 100° C.

There therefore remains a need for improved Ziegler-Natta catalysts, and improved methods of making the catalysts.

### BRIEF SUMMARY OF THE INVENTION

One embodiment of the invention relates to a catalyst, comprising, a solid reaction product of: a non-halide containing organic compound (A) comprising an element from Groups Ia, IIa, IIb, IIIb, IVb, VIIa, and VIII; a non-halide containing transition metal compound (B) comprising a transition metal from Groups IVa, Va, and Via; and an organo-aluminum halide represented by AlR(R′)ₙ, wherein R represents a C₁-C₂₀ hydrocarbon radical, R′ represents a halide, and n represents 0≤n≤2. The catalyst has the following properties: a B:A ratio of from 0.1 to 5 mol/mol; a catalyst size, (D₅₀), of from 3 to 70 microns; and an ethylene polymerization activity value of from 3.0 to 15.0 Kg-PE/mmol-TM/h.

Another embodiment of the invention relates to a process for producing the catalyst. In a first step, compound (A) is reacted with a branched alcohol, at a temperature of no more than 75° C., to obtain a first product. In a second step, compound (B) may be added to the first product.

Another embodiment of the invention relates to a method of polymerizing an olefin, comprising reacting an olefin monomer, such as ethylene, propylene, butylene, pentene, 2-methyl pentene, hexene, or octene, in the presence of the catalyst.

### BRIEF DESCRIPTION OF THE DRAWING

FIG. 1 represents a schematic depicting a method for catalyst synthesis, as an embodiment of the invention.

### DETAILED DESCRIPTION OF THE INVENTION

To overcome the above-noted problems associated with Ziegler-Natta catalysts and their preparation, the inventors of this invention have discovered novel Ziegler-Natta catalysts, as well as novel methods of their preparation. The inventors have surprisingly discovered that not using any kind of partially or completely chlorinated metal compound(s) in making the first product solution, such as titanium halide alkoxide (TiXₙ(OR)₄₋ₙ, where X is an halide and R is an alkyl/aryl group), leads to the formation of a highly stable solution. An aspect of the invention therefore involves the preparation of a first product solution that is stable over time, e.g., no signs of precipitation in a solution obtained by reacting dialkyl magnesium with titanium alkoxide, for significant periods of time, for example more than three months, more than six months, more than a year, or longer.

Advantages of the methodology of the catalyst synthesis include: (i) the methodology saves energy for the process involved in the catalyst synthesis by preparing the Mg(OR)₂+Ti(OR′)₄ complex at room temperature; (ii) selection of donor type in the catalyst is helpful in preparing different grades of PE in terms of their physical properties, including molecular weight, comonomer distribution and bulk density; and (iii) suppliers for the magnesium ethoxide are limited in the market, therefore, ability to prepare catalyst using alternative precursors is helpful in diversifying the methodology to prepare the ZN catalyst.

Accordingly, one aspect of this invention relates to a catalyst that comprises a solid reaction product of (i) a non-halide containing organic compound (A) comprising an element from Groups Ia, IIa, IIb, IIIb, IVb, VIIa, and VIII; (ii) a non-halide containing transition metal compound (B) comprising a transition metal from Groups IVa, Va, and Via; and (iii) an organo-aluminum halide represented by AlR(R′)ₙ, wherein R represents a C₁-C₂₀ hydrocarbon radical, R′ represents a halide, and n represents 0≤n≤2.

Compound (A) may include one or more of any element from Groups Ia, IIa, IIb, IIIb, IVb, VIIa, and VIII. Suitable compounds include hydrogen, lithium, sodium, potassium, rubidium, cesium, francium, beryllium, magnesium, calcium, strontium, barium, radium, boron, aluminum, gallium, indium, titanium, carbon, silicon, germanium, tin, lead, nitrogen, phosphorus, antimony, bismuth, oxygen, sulfur, selenium, and tellurium.

In some embodiments, compound (A) contains magnesium. For instance, compound (A) may comprise magnesium and one or more C₁-C₁₀ alkyl groups. Suitable compounds include dialkyl magnesium, wherein each alkyl of the dialkyl comprises at least one member selected from the group consisting of methyl, ethyl, propyl, butyl, pentyl, hexyl, and octyl. In some embodiments, compound (A) comprises at least one of dibutyl magnesium and butylethyl magnesium.

Compound (B) may include one or more of any transition metal elements from Groups IVa, Va, and VIa. Suitable compounds include scandium, titanium, vanadium, chromium, manganese, yttrium, zirconium, niobium, molybdenum, lanthanum, hafnium, tantalum tungsten, and rhenium.

In some embodiments, compound (B) contains titanium. For instance, compound (B) may comprise titanium and one or more C₁-C₁₀ alkoxide groups. Suitable compounds include dialkoxide titanium compounds, such as titanium methoxide, titanium ethoxide, titanium dipropoxide, titanium butoxide, titanium pentoxide, and titanium hexoxide.

The organo-aluminum halide compound is represented by AlR(R′)ₙ, wherein R represents a C₁-C₂₀ hydrocarbon radical, such as C₁-C₁₀, C₁-C₆, or C₁-C₄; R′ represents a halide (or halide thereof); and n represents 0≤n≤2, such as 1 or 2. The halide, or halide thereof, in the organo-aluminum halide compound can include at least one member selected from the group consisting of boron, aluminum, gallium, indium, fluorine, chlorine, and bromine.

The catalyst exhibits one or more of the following properties: (i) a Compound B:Compound A (B:A) ratio of from 0.1 to 5 mol/mol, such as 0.1 to 2, or 0.5 to 2; (ii) a catalyst size, (D₅₀), of from 3 to 70 microns, such as 5 to 50, or 10 to 20; and (iii) an ethylene polymerization activity value of from 3.0 to 15.0 Kg-PE/mmol-TM/h, such as 3.0 to 12.0, or 3.2 to 11.5. In some embodiments, the catalyst exhibits two of three properties and in other embodiments, the catalysts exhibit all three properties. For instance, the catalyst may exhibit the following properties: (i) a B:A ratio of from 0.1 to 5 mol/mol; (ii) a catalyst size, (D₅₀), of from 10 to 20 microns; and (iii) an ethylene polymerization activity value of from 3.0 to 15.0 Kg-PE/mmol-TM/h.

D₅₀ is a statistical measure of the mean particle size of substance. Particle size may be measured by dynamic light scattering (DLS). For the examples included herein, catalyst size (D50) was measured via DLS using a Mastersizer 3000™ equipped with an Aero S™ dry powder dispenser and Hydro EV™ wet material dispersion unit all available from Malvern Panalytical, of Malvern, United Kingdom.

Another embodiment of this invention relates to a process for preparing the catalyst. The process may include a first step of reacting compound (A) with a branched alcohol to obtain a first product. The reaction temperature during the first step is no more than 75° C., for instance, no more than 70° C., no more than 65° C., no more than 60° C., no more than 55° C., no more than 50° C., no more than 45° C., no more than 40° C., no more than 35° C., no more than 30° C., or no more than room temperature. The reaction may take place under continuous stirring, such as at a tip speed of from 0.2 m/s to 1.25 m/s.

The branched alcohol may be a branched C₃-C₁₀ alcohol, such as Isopropanol, Isobutanol, tert-Butanol, Isopentanol, Neopentanol, tert-Pentanol, 2-Methyl-1-pentanol, 3-Methyl-1-pentanol, 2-Methyl-2-pentanol, 2-Ethyl-1-butanol, 3,3-Dimethyl-2-butanol, 2-Methyl-1-hexanol, 3-Methyl-1-hexanol, 2,3-Dimethyl-2-pentanol, 2-Ethyl-1-hexanol, 2-Methyl-2-heptanol, 3,3-Dimethyl-1-hexanol, 3,5,5-Trimethyl-1-hexanol, 2,2-Dimethyl-3-pentanol, 2-Methyl-2-nonanol, or 2,6-Dimethyl-4-heptanol. In one embodiment, the branched alcohol is 2-Methyl-1-hexanol.

The reaction may include a second step that involves adding compound (B) to the first product. Compound (B) may be added to the first product in a variety of ways. Compound (B) may be added to the solution comprising the first product, to obtain a solution comprising a second product. In this embodiment, a viscosity of the solution comprising the second product is typically less than a viscosity of the solution comprising the first product, and the second-adding step occurs after first-adding step.

Alternatively, compound (B) may be added to an organic solvent, which is then added to a solution comprising the first product, to obtain a second product. The organic solvent may be any compatible organic solvent known to those of skill in the art, such as THF.

After compound (B) has been added to compound (A) to form a second product, the second product is then reacted with the organo-aluminum halide. In one embodiment, this reaction takes place at temperatures of at least 50° C., such as at least 60° C., or at least 65° C., to form a catalyst mixture. To precipitate the catalyst, the reaction is carried out at, or lowered to, a temperature of no more than 10° C., for instance, no more than 5° C., no more than 3° C., or no more than 0° C. The process can further include washing and drying the catalyst precipitated from the catalyst mixture.

Another embodiment of this invention relates to a method of polymerizing an olefin, comprising reacting one or more olefin monomers in the presence of the above-described catalyst. Suitable olefin monomers include ethylene, propylene, butylene, pentene, 2-methyl pentene, hexene, octene, and combinations thereof.

### EXAMPLES

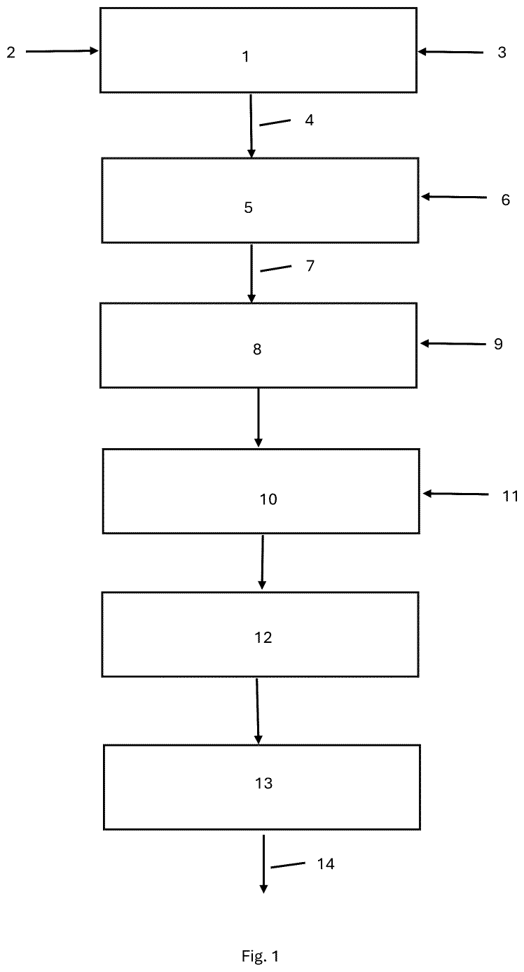

FIG. 1 represents a schematic of depicting a method for catalyst synthesis, as an embodiment of the invention. In this schematic, all manipulations in catalyst synthesis were performed under nitrogen atmosphere and flame dried glassware. In the first step 1,The RR′Mg 2 is diakyl magnesium such as butylethyl magnesium or butyloctyl magnesium that may be used in the form of alkane (preferably heptane) solution, mixed with 2-ethyl hexanol 3 at room temperature slowly to form the magnesium alkoxide (Mg/2-ethyl hexanol=0.1-2 (mol/mol)) 4. This mixing step is performed in the absence of an aluminum species. Thereafter, in the next step 5, Ti(OBu)₄ 6 was added in the above solution 4 at the room temperature under stirring (Ti/Mg=0.1-2 (mol/mol)), to form a homogeneous fluid 7 containing magnesium and titanium in pre-precipitated form. This sequence removes the need to heat solutions used in the mixing, to temperatures higher than room temperature.

In an optional step 8, the donor (electron-donor) 9 is an optional organic-base reagent that can be optionally added in the catalyst to yield high molecular weight PE and/or if α-olefin incorporation is desired in the final polymer. Suitable donors include tetrahydrofuran, anisole, resorcinol-based ethers, and also include esters, phthalates and succinates as well. The donor was added at the reflux temperature of the used solvent (e.g. heptane) and mixed for an hour.

Thereafter in another step 10, add the heptane solution of the alkylaluminum chloride 11 (particularly ethyl aluminum dichloride, Cl/(OR+OBu)=0.5-2 mol/mol) slowly at the room temperature in one hour followed by increase in temperature up to reflux temperature of heptane in step 12 for an hour followed by catalyst washing in step 13 with heptane and use the sedimented catalyst 14 for the olefin polymerization.

### Comparative Example 1 (CE 1)

Magnesium ethoxide (0.18 mol) was mixed with titanium tetrabutoxide (0.36 mol; Ti/Mg=2 mol/mol) in a round bottom flask at room temperature and heated at 150° C. for 4 hours. The obtained highly viscous reaction product was subsequently chlorinated using ethyl aluminum dichloride (EADC, 37 wt. % solution in hexane; Cl/OR=2.0 mol/mol; where OR (alkoxy) refers to ethoxy and butoxy groups from magnesium ethoxide and titanium butoxide) in an hour at room temperature followed by heating at 45° C. for 90 min followed by washing with hexane and drying. The reaction mixture was washed three times with hexane (100 mL) and twice with pentane (100 mL), followed by drying. The first three washings were performed at the 45° C., while any remaining washings were performed at the room temperature. The resulting dried powder, containing titanium 17.9 wt. %, magnesium 4.7 wt. %, and aluminum 2.8 wt. %, was used as a pre-catalyst for polymerization.

Comparative Example 1 was made in accordance with certain embodiments disclosed in U.S. Pat. Nos. 6,545,106 and 3,901,863.

### Comparative Example 2 (CE 2)

Magnesium ethoxide (0.18 mol) was mixed with titanium tetrabutoxide (0.18 mol; Ti/Mg=1 mol/mol) in a round bottom flask at room temperature and heated at 140° C. for 4 hours. The obtained highly viscous reaction product was subsequently chlorinated using ethyl aluminum dichloride (EADC, 37 wt. % solution in hexane; Cl/OR=2.2 mol/mol; where OR (alkoxy) refers to ethoxy and butoxy groups from magnesium ethoxide and titanium butoxide) in an hour at room temperature followed by heating at 45° C. for 90 min followed by 60° C. for 45 min. Thereafter, the reaction mixture was subjected to washing with hexane and drying. The reaction mixture was washed three times with hexane (100 mL) and twice with pentane (100 mL), followed by drying. The first three washings were performed at the 45° C., while any remaining washings were performed at the room temperature. The resulting dried powder, containing titanium 12.0 wt. %, magnesium 7.5 wt. %, and aluminum 5.1 wt. %, was used as a pre-catalyst for polymerization.

Comparative Example 2 was made in accordance with certain embodiments disclosed in U.S. Pat. Nos. 7,897,710 and 3,901,863.

### Inventive Example 1 (IE 1)

A butylethyl magnesium solution (0.25 mol of Mg) in alkane was added to a 500 mL reactor. Subsequently, 2-ethyl hexanol was slowly introduced (2-ethyl hexanol/Mg=2 mol/mol), resulting in a viscous solution at room temperature. Titanium butoxide (Ti/Mg=2 mol/mol) was then added to this solution under continuous stirring, which significantly reduced the viscosity. Following this, ethylaluminum dichloride (EADC, Cl/alkoxy=2.0 mol/mol) in hexane (37 wt. % EADC in hexane) was added over a period of 1 hour at 0° C. The mixture was then stirred at room temperature for 1 hour and subsequently at 65° C. for 2 hours. The reaction mixture was washed three times with hexane (100 mL) and twice with pentane (100 mL), followed by drying. The first three washings were performed at the 65° C., while any remaining washings were performed at the room temperature. The resulting dried powder, containing titanium 12.7 wt. %, magnesium 10.1 wt. %, and aluminum 3.1 wt. %, was used as a pre-catalyst for polymerization.

### Inventive Example 2 (IE 2)

A butylethyl magnesium solution (0.25 mol of Mg) in alkane was added to a 500 mL reactor. Subsequently, 2-ethyl hexanol was slowly introduced ((2-ethyl hexanol/Mg=2 mol/mol), resulting in a viscous solution at room temperature. Titanium butoxide (Ti/Mg=2 mol/mol) was then added to this solution under continuous stirring, which significantly reduced the viscosity. Tetrahydrofuran (THF, Ti/THF=1 mol/mol) was added to the resultant solution and stirred for 15 minutes. Following this, ethylaluminum dichloride (EADC, Cl/alkoxy=2.0 mol/mol) in hexane (37 wt. % EADC in hexane) was added over a period of 1 hour at 0° C. The mixture was then stirred at room temperature for 1 hour and subsequently at 65° C. for 2 hours. The reaction mixture was washed three times with hexane and twice with pentane, followed by drying. The first three washings were performed at the 65° C., while remaining were performed at the room temperature. The resulting dried powder, containing titanium 9.3 wt. %, magnesium 7.1 wt. %, aluminum 5.3 wt. % and THF 9.8 wt. % was used as a pre-catalyst for polymerization.

### Inventive Example 3 (IE 3)

A dibutyl magnesium solution (0.25 mol of Mg) in alkane was added to a 500 mL reactor. Subsequently, 2-ethyl hexanol was slowly introduced ((2-ethyl hexanol/Mg=2 mol/mol), resulting in a viscous solution at room temperature. Titanium butoxide (Ti/Mg=1 mol/mol) was then added to this solution under continuous stirring, which significantly reduced the viscosity. Following this, ethylaluminum dichloride (EADC, Cl/alkoxy=2.2 mol/mol) in hexane (37 wt. % EADC in hexane) was added over a period of 1 hour at 0° C. The mixture was then stirred at room temperature for 1 hour and subsequently at 65° C. for 2 hours. The reaction mixture was washed three times with hexane and twice with pentane, followed by drying. The first three washings were performed at the 65° C., while remaining were performed at the room temperature. The resulting dried powder, containing titanium 8.4 wt. %, magnesium 14.0 wt. %, and aluminum 3.2 wt. %, was used as a pre-catalyst for polymerization.

### Inventive Example 4 (IE 4)

A dibutyl magnesium solution (0.25 mol of Mg) in alkane was added to a 500 mL reactor. Subsequently, 2-ethyl hexanol was slowly introduced ((2-ethyl hexanol/Mg=2 mol/mol), resulting in a viscous solution at room temperature. Titanium butoxide (Ti/Mg=1 mol/mol) was then added to this solution under continuous stirring, which significantly reduced the viscosity. Tetrahydrofuran (THF, Ti/THF=1 mol/mol) was added to the resultant solution and stirred for 15 minutes. Following this, ethylaluminum dichloride (EADC, Cl/alkoxy=2.2 mol/mol) in hexane (37 wt. % EADC in hexane) was added over a period of 1 hour at 0° C. The mixture was then stirred at room temperature for 1 hour and subsequently at 65° C. for 2 hours. The reaction mixture was washed three times with hexane and twice with pentane, followed by drying. The first three washings were performed at the 65° C., while any remaining washings were performed at the room temperature. The resulting dried powder, containing titanium 3.8 wt. %, magnesium 3.7 wt. %, and aluminum 1.1 wt. %, was used as a pre-catalyst for polymerization.

### Inventive Example 5 (IE 5)

A butylethyl magnesium solution (0.25 mol of Mg) in alkane was added to a 500 mL reactor. Subsequently, 2-ethyl hexanol was slowly introduced ((2-ethyl hexanol/Mg=2 mol/mol), resulting in a viscous solution at room temperature. Titanium butoxide (Ti/Mg=0.5 mol/mol) was then added to this solution under continuous stirring, which significantly reduced the viscosity. Following this, ethylaluminum dichloride (EADC, Cl/alkoxy=1.6 mol/mol) in hexane (37 wt. % EADC in hexane) was added over a period of 1 hour at 0° C. The mixture was then stirred at room temperature for 1 hour and subsequently at 65° C. for 2 hours. The reaction mixture was washed three times with hexane and twice with pentane, followed by drying. The first three washings were performed at the 65° C., while any remaining washings were performed at the room temperature. The resulting dried powder, containing titanium 4.2 wt. %, magnesium 14.5 wt. %, and aluminum 3.6 wt. %, was used as a pre-catalyst for polymerization.

### Ethylene Polymerization

Ethylene (C₂) homopolymerization was conducted in a 1.3-gallon reactor containing 1.8 L of hexane. Triethyl aluminum (Al/Ti=15 mol/mol) was added as a scavenger and cocatalyst. Subsequently, 30 mg of precatalyst was introduced into the reactor, followed by the addition of ethylene (C₂) and hydrogen (H₂). The H₂/C₂ ratio was maintained at 34 mol/kmol, with the total reactor pressure set at 220 psi. The polymerization was conducted for 1 hour at 85° C. The resulting product was filtered, and the obtained powder was dried under vacuum at 80° C. until there is no further mass change. The dried polymer mass was then used to determine catalyst activity and for further polymer characterization.

The polymerization results are as shown below, in Table 1, for pre-catalysts from Example 1-6.

TABLE 1
Polymerization results

| | | Precatalyst | Polymerization | Melt Index |
|---|---|---|---|---|
| | Ti/Mg | Size D₅₀ | Activity | (21.6 kg at 190° C.) |
| Precatalyst | mol/mol | (μm) | Kg-PE/mmol-Ti/h | g/10 min |
| CE 1 | 2 | 12 | 2.6 | 13.1 |
| CE 2 | 1 | 8 | 4.3 | 20.1 |
| IE 1 | 2 | 11 | 3.7 | 3.7 |
| IE 2 | 2 | 19 | 4.2 | 1.9 |
| IE 3 | 1 | 11 | 5.0 | 4.4 |
| IE 4 | 1 | 16 | 6.1 | 2.6 |
| IE 5 | 0.5 | 14 | 10.9 | 42.2 |

The inventive catalysts show higher ethylene polymerization activity than the comparative example catalysts for same Ti/Mg ratios. For instance, ethylene polymerization activity of IE 1>CE 1. In similar way, for IE 3>CE 2. Additional trends may be shown by reviewing the data in Table 1.

1. A catalyst, comprising, a solid reaction product of:
a non-halide containing organic compound (A) comprising an element from Groups Ia, IIa, IIb, IIIb, IVb, VIIa, and VIII,
a non-halide containing transition metal compound (B) comprising a transition metal (TM) from Groups IVa, Va, and VIa, and
an organo-aluminum halide represented by AlR(R′)ₙ, wherein R represents a C₁-C₂₀ hydrocarbon radical, R′ represents a halide, and n represents 0≤n≤2, wherein the catalyst has:
a B:A ratio of from 0.1 to 5 mol/mol,
a catalyst size, (D₅₀), of from 3 to 70 microns, and
an ethylene polymerization activity value of from 3.0 to 15.0 Kg-PE/mmol-TM/h.

2. The catalyst composition according to claim 1, wherein compound (A) comprises at least one element selected from the group consisting of hydrogen, lithium, sodium, potassium, rubidium, cesium, francium, beryllium, magnesium, calcium, strontium, barium, radium, boron, aluminum, gallium, indium, titanium, carbon, silicon, germanium, tin, lead, nitrogen, phosphorus, antimony, bismuth, oxygen, sulfur, selenium, and tellurium.

3. The catalyst composition according to claim 1, wherein compound (A) comprises magnesium.

4. The catalyst composition according to claim 1, wherein compound (A) is a compound comprising magnesium and one or more C₁-C₁₀ alkyl groups.

5. The catalyst composition according to claim 1, wherein compound (A) comprises dialkyl magnesium, wherein each alkyl of the dialkyl comprises at least one member selected from the group consisting of methyl, ethyl, propyl, butyl, pentyl, hexyl, and octyl.

6. The catalyst composition according to claim 1, wherein compound (A) comprises at least one of dibutyl magnesium and butylethyl magnesium.

7. The catalyst composition according to claim 1, wherein compound (B) comprises at least one member selected from the group consisting of scandium, titanium, vanadium, chromium, manganese, yttrium, zirconium, niobium, molybdenum, lanthanum, hafnium, tantalum tungsten, and rhenium.

8. The catalyst composition according to claim 1, wherein compound (B) comprises titanium.

9. The catalyst composition according to claim 1, wherein compound (B) comprises titanium and a C₁-C₁₀ alkoxide.

10. The catalyst composition according to claim 1, wherein compound (B) comprises dialkoxide titanium.

11. The catalyst composition according to claim 1, wherein the organo-aluminum halide comprises at least one member selected from the group consisting of boron, aluminum, gallium, indium, fluorine, chlorine, and bromine.

12. A process for producing a catalyst according to claim 1, comprising:
first-reacting compound (A) with a branched alcohol, at a temperature of no more than 75° C., to obtain a first product.

13. The process according to claim 12, wherein said first reacting is carried out a temperature of no more than 70° C.

14. The process according to claim 12, further comprising, second-adding compound (B) to a solution comprising the first product, to obtain a solution comprising a second product.

15. The process according to claim 12, further comprising, second-adding compound (B) and an organic solvent, to a solution comprising the first product, to obtain a second product.

16. The process according to claim 12, further comprising, second-adding compound (B) to a solution comprising the first product, to obtain a second product, and
second-reacting the second product with the organo-aluminum halide, to precipitate the catalyst.

17. The process according to claim 12, wherein said branched alcohol comprises a branched C₃-C₁₀ alcohol.

18. The process according to claim 12, wherein said first-reacting is carried out in the presence of a solvent and under continuous stirring, such as at a tip speed of from 0.2 m/s to 1.25 m/s.

19. The process according to claim 12, further comprising, second-adding compound (B) to a solution comprising the first product, to obtain a second product,
second-reacting the second product with the organo-aluminum halide to form a catalyst mixture, to precipitate the catalyst from the catalyst mixture, wherein second-reacting comprises heating the catalyst mixture at a temperature of at least 50° C.

20. (canceled)

21. A method of polymerizing an olefin, comprising:
reacting an olefin monomer in the presence of a catalyst according to claim 1.

22. (canceled)
